(19) United States
(12) Patent Application Publication
(10) Pub. No.: US 2012/0015076 A1
(43) Pub. Date: Jan. 19, 2012

(54) CHOCOLATE DELIVERY SYSTEM FOR LIVE MICROORGANISMS

(75) Inventor: Judy Davis, San Clemente, CA (US)

(73) Assignee: Hero Nutritionals, LLC, San Clemente, CA (US)

(21) Appl. No.: 13/181,355

(22) Filed: Jul. 12, 2011

Related U.S. Application Data
(60) Provisional application No. 61/363,326, filed on Jul. 12, 2010.

(51) Int. Cl. A23G 1/42

(52) U.S. Cl. 426/61; 426/519; 426/631

(57) ABSTRACT

A chewable composition for the oral delivery of live microorganisms is provided. The chewable composition includes a delivery vehicle and an active ingredient incorporated therein. The delivery vehicle may include a chocolate candy. The active ingredient may include a predetermined amount of at least one probiotic. The delivery vehicle may also include a predetermined amount of at least one prebiotic. The delivery vehicle may also include any combination of nutraceuticals, vitamins, minerals, antioxidants, soluble and insoluble fiber, herbs, plants, probiotics, prebiotics, antioxidants, amino acids, fatty acids, digestive enzymes, dietary supplements, or any other health promoting ingredient.

### RELATED APPLICATIONS

This application claims priority to U.S. Provisional Application No. 61/363,326, filed on Jul. 12, 2010, titled CHOCOLATE DELIVERY SYSTEM FOR LIVE MICROORGANISMS, which application is incorporated in its entirety by reference herein.

### BACKGROUND OF THE INVENTION

1. Field of the Invention

The invention relates generally to an edible, chewable chocolate composition, and more particularly, to an edible, chewable chocolate composition for the oral delivery of live microorganisms such as probiotics, where the chewable chocolate composition may include prebiotics, and methods for manufacturing the same.

2. Related Art

Each year, millions of men and women die from heart disease around the world. At least 90 million people in the United States alone report having some form of chronic illness like infections, diabetes, and cancer. These figures are astonishing. Recently, the medical community has discovered a new way to reduce the risk for coronary heart disease while boosting the body's immune system at the same time. The use of probiotics and prebiotics is one of the newest fields of nutritional research and offers promising benefits to the health of one's heart, immunity, and more.

Probiotics, often referred to as “friendly” or “good” bacteria, are living microorganisms that may be added to foodstuffs which, when consumed in adequate amounts, provide equilibration of the intestinal flora (microorganisms that live in the gastrointestinal tract), thus inhibiting harmful bacteria (e.g., toxin producing bacteria) growth. In general, it is believed that probiotic microorganisms produce organic acids such as lactic acid and acetic acid which inhibit the growth of pathogenic bacteria—bacteria that cause infectious diseases. Probiotic bacteria are therefore believed to be useful in the treatment and prevention of conditions caused by pathogenic bacteria. Further, probiotic microorganisms are believed to inhibit the growth and activity of putrefying bacteria and hence the production of toxic amine compounds. Probiotic bacteria are also believed to activate the immune function of the host. Research has shown that certain probiotics are useful in reducing inflammation, diarrhea, and infections in the digestive tract, lowering cholesterol and blood pressure, preventing colon cancer, and managing lactose intolerance.

Probiotics are available to consumers primarily in the form of dietary supplements, probiotic fortified foods, and fermented dairy products. For example, probiotics may be consumed as part of yogurt, fermented and unfermented milk, miso, tempeh, and some juices and soy beverages.

The most common groups of probiotic bacteria are Lactobacillus (lactic acid bacteria or “LAB”) and Bifidobacterium. Certain yeasts and Bacilli may also be used as probiotics. Within each group, there are different species, such as Lactobacillus acidophilus and Bifidobacterium bifidus, and within each species, there are different strains or varieties, such as Lactobacillus acidophilus NCFM and Bifidobacterium bifidus MF20/5.

The normal human digestive tract contains about 400 types of probiotic bacteria that reduce the growth of harmful bacteria and promote a healthy digestive system. The largest group of probiotic bacteria in the intestine is LAB, of which Lactobacillus acidophilus, found in yogurt, is the best known. Certain yeasts, such as Saccharomyces boulardii, are also considered probiotic substances.

Similar to probiotics, prebiotics are non-digestible substances that stimulate the growth and/or bioactivity of flora (beneficial bacteria) in the digestive system. Typically, prebiotics are carbohydrates (e.g., oligosaccharides and fructooligosaccharides); the most prevalent forms of prebiotics are nutritionally classed as soluble fiber. Dietary sources of prebiotics include soybeans, Jerusalem artichoke, onion, garlic, asparagus, bananas, raw oats, unrefined wheat, unrefined barley and yacon. Some of the oligosaccharides that naturally occur in breast milk are believed to play an important role in the development of a healthy immune system in infants. Other prebiotics include, for example, oligofructose and inulin.

Previously, a selection of vitamin supplements has been made available for children in a chewable candy form that is pleasant tasting and palatable. Another delivery system having great potential is chocolate in its many forms. Chocolate has become one of the most popular flavors with consumers around the world, especially in the form of candy bars and smaller individually-wrapped pieces, and chocolate may potentially have its own beneficial health effects.

In general, chocolate is created from the cocoa bean, which is harvested, fermented, and dried, and then shipped to a chocolate manufacturing facility. At the chocolate manufacturers, the beans are cleaned, roasted, and graded. The shell is then removed, resulting in cacao nibs, which are then ground into a thick creamy paste, known as chocolate liquor or cocoa paste. The next step in the process is blending, where the chocolate liquor may be mixed with cocoa butter, sugar, milk or milk powder, and vanilla. It is in this step where the various types of chocolate are made, including: dark chocolate, milk chocolate (by adding milk or milk powder), and white chocolate (having no cocoa solids, only cocoa butter). The blended chocolate is then conched, tempered, molded, and wrapped for eventual distribution to consumers.

Even with the popularity of chocolate and the increasing use of probiotics and prebiotics as health supplements, to date, chocolate candies have not been utilized as delivery systems for probiotics and prebiotics. Thus, a need exists in the art for a safe, easily digestible and palatable delivery system that enables the effective delivery of live microorganisms with or without prebiotics, to the human body to be easily and quickly digested by users of all ages, where the delivery system may be manufactured without compromising the effectiveness of the live microorganisms.

### SUMMARY

An edible, digestible composition is provided that includes a chewable delivery system in the form of a chocolate candy, and a predetermined dosage of probiotics and/or prebiotics, originally added in either liquid, frozen concentrate, or freeze-dried form. By ingesting the chocolate candy, the consumer is able to directly supply his or her body with active health ingredients.

In some implementations, the chocolate candy may include a chocolate liquor, cocoa butter and natural cane sugar. In some implementations, the chocolate candy may also include soy lecithin and vanilla. In some implementations, the chocolate candy may also include milk or milk powder.

According to another implementation, a method of manufacturing a chocolate delivery system is provided. Selected cacao nibs may be blended with additional ingredients to produce a chocolate liquor. A compound including at least one live microorganism may be combined with the chocolate liquor. The combination of the chocolate liquor and the compound may be conched. Finally, the conched combination of chocolate liquor and the compound may be tempered to form a chocolate candy.

Other devices, apparatus, systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE FIGURES

The invention may be better understood by referring to the following figure. The components in the figure are not necessarily to scale, emphasis instead being placed upon illustrating the principles of the invention.

FIG. 1 is a flow diagram that illustrates one example of a method of manufacturing a chocolate delivery system for delivering an active ingredient in accordance with the present invention.

### DETAILED DESCRIPTION

The present invention relates to a method of manufacturing a chocolate delivery system designed to enhance the delivery of live microorganisms (“LMOs”), namely, probiotics. The edible, solid chocolate candy delivery system may include prebiotics. The delivery system includes a primary active ingredient(s) (a dosage of probiotics and in some implementations, a dosage of prebiotics) to provide the desired effect (e.g., equilibration of intestinal flora), and a delivery vehicle (e.g., chocolate candy) to contain the active ingredient(s) for delivery.

The primary active ingredient(s) of the present invention may include live microorganisms alone or in combination with other health supplements and/or compounds. For example, in one implementation the active ingredient may include at least one probiotic alone or in combination with a prebiotic. In some implementations, the primary active ingredient may be provided in liquid, frozen concentrate, or freeze-dried form for incorporation in the chocolate candy. As for the dosage, probiotics and/or prebiotics of the present invention are generally expressed in terms of grams or milligrams, but may also be expressed in active units, or international units (IU). By way of example only, a single piece of chocolate candy may have 500-1000 mg of probiotics. In some implementations, the dosages of probiotic and/or prebiotic in each chocolate candy should be relatively low, thus allowing the consumer to adjust his/her intake of probiotic and/or prebiotic based on nutritional guidelines applicable to the particular individual.

As used herein, the term “probiotic” is intended to include microorganisms such as bacteria or fungi, either individually or in combination, which exhibit a beneficial effect on human health. Non-limiting examples of probiotics that may be used in conjunction with the present invention include: bifido bacteria (e.g., Bifidobacterium LAFTO B94, Bifidobacterium animalis, Bifidobacterium breve, Bifidobacterium infantis, Bifidobacterium longum and Bifidobacterium bifidum); lactobacilli (“LAB”) (e.g., Lactobacillus acidophilus, Lactobacillus casei, Lactobacillus paracasei, Lactobacillus johnsonii, Lactobacillus plantarum, Lactobacillus reuteri, Lactobacillus rhamnosus, Lactobacillus helveticus, Lactobacillus bulgaricus and Lactobacillus gasseri); saccharomyces (e.g., Saccharomyces boulardii); lactococci (e.g., Lactococcus lactis); streptococci (e.g., Streptococcus thermophiles); propionibacteria; bacilli (e.g., Bacillus coagulans); combinations of the foregoing; and any other microorganism which may be demonstrated to have beneficial effects on the health of the host. The probiotic may be mixed with a prebiotic material (e.g., to form a symbiotic material or compound).

As used herein, the term “prebiotic” refers to a substance such as a protein, peptide, or carbohydrate that, when consumed by a user, allows specific changes in the composition and/or activity in the gastrointestinal microflora so as to confer health benefits and well-being to the user. Non-limiting examples of prebiotics that may be used in conjunction with the present invention include resistant starch, potato starch or high amylose starch such as Starplus, modified starches (including carboxylated starches, acetylated, propionated, and butyrated starches), non-digestible oligosaccharides such as fructooligosaccharides, glucooligosaccharides, xylooligosaccharides, galactooligosaccharides, arabinoxylans, arabinogalactans, galactomannans, polydextrose, oligofructose, inulin, derivatives of these, but not excluding other oligosaccharides able to exert prebiotic effects, other soluble fibers, and combinations of the foregoing. Dietary sources of prebiotics may include, but are not limited to, soybeans, Jerusalem artichokes, jicama, chicory root, raw oats, unrefined wheat, yacon, unrefined barley, milk, almonds, honey, garlic, leeks, raw onion, etc.

As used herein, the term “synbiotic” means a combination of one ore more probiotics and one or more prebiotics which together have a synergistic beneficial effect on human health.

As used herein, the terms “LMO” or “LMOs” refer to compositions of living microorganisms that include one or more strains of probiotic microorganisms, and which, in some implementations, may initially be provided in liquid, frozen concentrate, or freeze-dried form.

The primary active ingredient, i.e., a probiotic either alone or in conjunction with a prebiotic, is delivered in a delivery vehicle that is palatable and easy to swallow. In one implementation, the delivery vehicle is a chewable chocolate candy to facilitate swallowing. The delivery vehicle may include a sweetener(s), a stabilizer(s) or binder(s), a humectant(s), and/or natural and/or artificial flavors. The delivery vehicle may include natural and/or artificial colors and preservatives. In one implementation, the delivery vehicle may include glucose syrup, natural cane juice, gelatin, citric acid, lactic acid, natural colors, natural flavors, fractionated coconut oil, and carnauba wax.

In addition to probiotics and/or prebiotics, the delivery system may include any combination of vitamins, minerals, antioxidants, soluble and insoluble fiber, herbs, plants, fatty acids, amino acids, digestive enzymes, and any other health promoting ingredient. The inclusion of a particular dietary supplement will be dependent in part on its compatibility with the probiotic and/or the prebiotic.

### Manufacturing of Delivery System

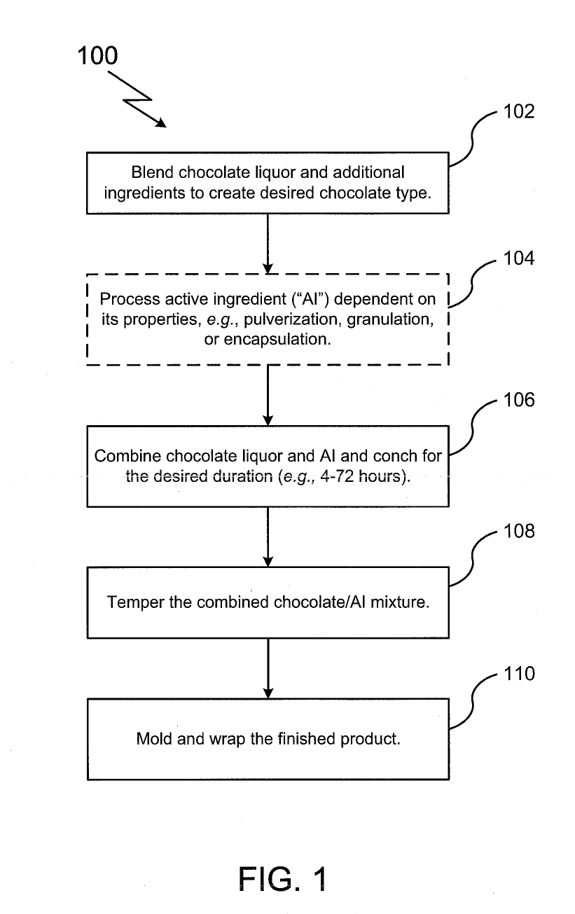

Turning now to FIG. 1, an example of a method 100 for manufacturing a chocolate delivery system of the present invention is disclosed. In general, the method 100 of manufacturing the chocolate delivery system may include three main phases: (i) blending; (ii) conching; and (iii) tempering.

In the first step 102, chocolate liquor made from cacao nibs, which is a combination of cocoa butter (usually 50-60%) and cocoa solids, may be blended with additional ingredients to obtain the desired individual chocolate recipe for the delivery vehicle. In general, dark chocolate includes sugar, cocoa butter, cocoa liquor, and vanilla (optional). Milk chocolate may include the same ingredients as dark chocolate, with the addition of milk or milk powder. White chocolate may include the same ingredients as dark chocolate, except without any cocoa solids. An emulsifying agent such as soy lecithin may be added to improve the texture of the chocolate.

In optional step 104, the appropriate dosage of the desired active ingredient (e.g., at least one probiotic, with or without a prebiotic) may undergo additional processing before being mixed with the blended chocolate and going to the conching step 106. In the conching step 106, the blended chocolate may be placed in a container filled with metal beads, which act as grinders, or in more modern conches, a rotary container with mixing blades. In general, in the conching step 106, the blended chocolate mass may be kept warm and in liquid form by frictional heat while it is “kneaded” at controlled temperatures (generally around 110-140° F.). The conching step 106 may be carried out for four to six hours for lower-quality chocolate and in some implementations, seventy-two hours or longer for high-quality chocolate. The purpose of the conching step 106 is to reduce the size of the particles in the chocolate mass so as to produce a chocolate that is smooth and thus more desirable to the consumer. Generally, this requires reducing the size of the particles in the chocolate to micron-size particles. Additionally, the conching step 106 is believed to improve the taste of the chocolate by removing harsh-tasting components and developing the more desirable flavor components of the chocolate. Thus, the duration of the conching step 106 is dependent on many factors and varies with the type of chocolate desired to be produced and the quality of the original ingredients.

Depending on the properties of the active ingredient (e.g., LMOs with or without prebitotics), it may be necessary to process the active ingredient (at step 104) if, for example, its particle size is too large for the conching step 106. For example, if the active ingredient is in freeze dried form, it may be advantageous to pulverize it into a finer powder with a substantially uniform particle size. If the active ingredient is ground extremely fine, this may reduce the conching time at step 106. In some implementations it may be necessary, in order to ensure an even distribution of the active ingredient throughout the chocolate mass, to granulate the active ingredient at step 104; i.e., to collect multiple active ingredient particles together by creating bonds between them, prior to its being conched with the chocolate liquor at step 106.

In some implementations in which the active ingredient is in the form of a liquid or frozen concentrate (e.g., yogurt as a source of probiotics), it may not be necessary for this ingredient to go through step 104, but such an ingredient may go directly to the conching step 106. For heat sensitive LMOs and other ingredients, encapsulation may be required before the ingredient is introduced to the conching step 106.

In step 106, the appropriate dosage of the desired active ingredient may be added to the refined and blended chocolate from step 102, and conching of this mixture may continue for the desired duration. Depending on the type of active ingredient, an emulsification process may be utilized as an alternative to (or in addition to) the conching step 106. In some implementations in which the active ingredient is emulsified within the chocolate liquor, there may be less of a need to pre-process the active ingredient at step 104.

In the tempering step 108, the conched chocolate may be heated, cooled, and then reheated to obtain the proper crystalline form and a uniform texture and appearance. In the final step 110, the tempered chocolate may be poured into molds of various sizes and shapes for candy bars or individually-wrapped pieces, which may then be wrapped and packaged for distribution to wholesale and retail outlets. The tempered chocolate may also be formed into large blocks, which may then be stored and/or transported to confectionary makers or other manufacturers who reheat and reprocess the chocolate to make their own products for their customers. These confectionary makers and other manufacturers may also purchase tempered chocolate that does not contain any active ingredients and produce their own chocolate delivery systems by repeating steps 104 through 110 of method 100.

The present invention encompasses a chocolate delivery system comprising a chewable, solid chocolate candy and at least one active ingredient that is dispersed throughout the chocolate candy in a substantially uniform mariner In one implementation, the chocolate delivery system may be used to deliver LMOs to enhance the health of the consumer. Such LMOs may include probiotics such as bifido bacteria, lactobacilli, saccharomyces, lactococci, streptococci, propionibacteria. In some implementations, the chocolate delivery system may include at least one probiotic and at least one prebiotic derived from a food source such as soybeans, Jerusalem artichoke, onion, garlic, asparagus, bananas, raw oats, unrefined wheat, barley, yacon and the like, in liquid, frozen concentrate, or freeze-dried form.

For example, in one implementation of a chocolate delivery system including probiotics, a single piece of chocolate candy of a weight of 7-10 grams may include a probiotic concentration of approximately 100 million Lactobacillus casei shirota, which is the equivalent of 1 mL of Yakult™. Thus, in a single piece of candy of 10 grams, the active ingredient (AI) may constitute approximately 10.0% by weight. However, the amount of the AI added to the candy formulation may vary based on, for example, the particular microorganism used. The chocolate delivery system will preferably be balanced to ensure that the eventual candy product will have a pleasant taste and will have the desired texture. Depending on the AI being delivered, larger pieces of candy may be required or other flavorings and sweeteners may need to be added to the chocolate to mask the flavor of the AI in the more bitter formulations, for example. In some implementations, the serving size of the chocolate delivery system may be that of a standard size candy bar, e.g., 1.45-1.55 oz. (or 41-43 g).

In some implementations, the AI, in addition to probiotics, may include a prebiotic that is derived from, for example, soy, garlic, or banana extract, such that the chocolate delivery system is a synbiotic compound.

In addition to LMOs, the chocolate delivery system may also include pharmaceutical compounds, nutraceuticals (i.e., extracts of food purported to have a medicinal effect on human health, such as botanical and herbal extracts and antioxidants), food supplements such as vitamins and co-vitamins, minerals, amino acids, fatty acids, and digestive enzymes, or any other health promoting ingredient.

The chocolate delivery system may include one or more active ingredients, which may include any combination of the aforementioned prebiotics and/or other food supplements, such that the chocolate delivery system retains a palatable flavor, appearance, texture, and smoothness. The active ingredient(s) and any other supplemental ingredients will preferably be distributed throughout the delivery system in a substantially uniform manner. The delivery vehicle may further include natural colors, natural and artificial flavors, and preservatives that are commonly known to those skilled in the art. In some implementations, the chocolate delivery system may take the form of a chocolate coating that is applied over another type of candy, such as caramel or nougat; e.g., a typical candy bar.

The foregoing description of implementations has been presented for purposes of illustration and description. It is not exhaustive and does not limit the claimed invention to the precise form disclosed. Modifications and variations are possible in light of the above description or may be acquired from practicing the invention. The claims and their equivalents define the scope of the invention.

What is claimed is:

1. A chewable composition comprising:
chocolate and a compound including live microorganisms, wherein the compound is blended with the chocolate during conching of the chocolate.

2. The chewable composition of claim 1, wherein the compound includes at least one probiotic.

3. The chewable composition of claim 1, wherein the compound includes at least one prebiotic.

4. The chewable composition of claim 1, wherein the compound is symbiotic.

5. The chewable composition of claim 1, wherein the compound includes at least one additive selected from the group consisting of nutraceuticals, nutritional supplements and food supplements.

6. The chewable composition of claim 1, wherein the chocolate includes chocolate liquor, cocoa butter, and natural cane sugar.

7. The chewable composition of claim 6, further including soy lecithin and vanilla.

8. The chewable composition of claim 7, further including milk or milk powder.

9. A method of manufacturing a chocolate delivery system, the method comprising:
blending selected cacao nibs with additional ingredients to produce a chocolate liquor;
combining a compound including at least one live microorganism with the chocolate liquor;
conching the combination of chocolate liquor and the compound; and
tempering the conched combination of chocolate liquor and the compound to form a chocolate candy.

10. The method of claim 9, further comprising the steps of:
molding the chocolate candy into a selected shape; and
wrapping the molded candy.

11. The method of claim 9, wherein the additional ingredients include cocoa butter and milk or milk powder.

12. The method of claim 11, wherein the additional ingredients further include natural cane sugar, soy lecithin, and vanilla.

13. The method of claim 9, wherein the compound includes a probiotic.

14. The method of claim 9, wherein the compound includes a prebiotic.

15. The method of claim 9, wherein the compound is synbiotic.

16. A method of manufacturing a chocolate delivery system, the method including:
reheating a block of tempered chocolate;
adding at least one active ingredient (AI) to the reheated chocolate;
blending the at least one AI into the reheated chocolate; and
tempering the blended chocolate.

17. The method of claim 16, wherein the step of blending includes conching the reheated chocolate containing the at least one AI.

18. The method of claim 16, wherein the step of blending includes using an emulsifying agent to blend the reheated chocolate containing the at least one AI.

19. The method of claim 18, wherein the emulsifying agent is soy lecithin.

20. The method of claim 16, wherein the at least one AI is a probiotic microorganism.

21. The method of claim 16, wherein the at least one AI includes a prebiotic.

22. The method of claim 16, wherein the at least one AI is synbiotic.
